(19) United States
(12) Patent Application Publication
(10) Pub. No.: US 2024/0344778 A1
(43) Pub. Date: Oct. 17, 2024

(54) A STORAGE DEVICE FOR THERMAL ENERGY

(71) Applicant: David S.r.l., Caltanissetta (CT) (IT)

(72) Inventors: Gianluca TUMMINELLI, Caltanissetta (CT) (IT); Gaetano TUZZOLINO, Caltanissetta (CT) (IT); Calogero GATTUSO, Caltanissetta (CT) (IT); Fabio SANTORO, Caltanissetta (CT) (IT); Francesco DE PATRIZIO, Caltanissetta (CT) (IT); Eleonora Maria FLORIA, Caltanissetta (CT) (IT)

(21) Appl. No.: 18/292,578

(22) PCT Filed: Jul. 28, 2022
(86) PCT No.: PCT/IB2022/056993

§ 371 Date: Jan. 26, 2024

(30) Foreign Application Priority Data
Jul. 29, 2021 (IT) 102021000020384

(51) Int. Cl. F28D 20/00; F28D 20/02

(52) U.S. Cl. CPC F28D 20/0056; F28D 2020/0078; F28D 20/021

(57) ABSTRACT

A thermal energy storage device is disclosed and includes a thermovector unit and a thermoaccumulator unit, wherein: the thermoaccumulator unit comprises a granular thermoaccumulator material, the thermovector unit comprises an interstitial volume defined by the thermoaccumulator material of the thermoaccumulator unit, the interstitial volume being pervious with respect to a thermovector fluid configured to flow through the interstitial volume in a flow direction and in thermal exchange relationship with the granular thermoaccumulator material of the thermoaccumulator unit, for storage and release of thermal energy as a consequence of a thermal exchange with the thermovector fluid.

### FIELD OF THE INVENTION

The present invention refers to storage devices for thermal energy, specifically to static storage devices for thermal energy.

### PRIOR ART

The state of the art offers various examples of storage devices for thermal energy which may employ, as storage materials, fluids such as water, diathermic oil or molten salts, and which typically include moving mechanical components for moving and generally handling the accumulator fluids, which themselves may act as energy vector fluids.

The main problems of such devices are the need of a rather frequent maintenance, in order to ensure the efficiency of the device, the possible formation of fouling, the possible necessity of resorting to auxiliary heaters for the starting operations, in order to reduce the fluid viscosity.

As regards the (static) storage devices for thermal energy, wherein the accumulator material is solid, we may quote for example the storage systems based on cement/concrete for thermodynamic plants.

The accumulator material consists in a cast concrete block, within which there are embedded the operating/process conduits, which run throughout the block and reach one or more manifolds installed at the ends.

Such system, albeit not requiring frequent maintenance or disassembling, and albeit being economically very advantageous, exhibits limitations due to the insufficient thermodynamic performances of the accumulator material, particularly due to a low thermal conductivity which leads to low thermal energy transfer speeds (long charging and discharging times) and due to an (albeit slow) degradation of the quality of the stored energy, because of the thermal continuity among the various region of the single, bulky concrete mass.

Moreover, it must be kept in mind that the very low thermal conductivity of concrete leads to the impossibility of managing a high thermal power, i.e., high amounts of energy transferred per time unit, unless resorting to large exchange surfaces and big storage volumes.

The Applicant has already dealt with the problems mentioned in the above in the Italian Patent for Industrial Invention n. 102017000091905 (IT '905 in the following), proposing a technical solution wherein the achievement of the desired performances was associated with a single physical property typical of the thermoaccumulator material only: thermal diffusivity. IT '905 defines confidence intervals for the thermal diffusivity of the thermoaccumulator material, which practically exclude stone, refractory or concrete materials. The technical discussion included in IT '905 basically highlights two aspects:
a material having low thermal diffusivity offers low performances as regards the readiness of the thermal energy transfer from and towards the thermovector fluid, although it may generally have a proper volumetric thermal capacity;
a material having excessive thermal diffusivity is unable to offer performances adapted to the operation as a thermal storage unit, because it exhibits an unbalance between the thermal exchange properties (thermal conductivity) and the thermal storage or inertia (density and specific heat), the former being predominant over the latter, which would irreversibly shift the operating range towards the mere thermal exchange devices: an excessive readiness in thermal exchange together with a potentially insufficient volumetric thermal capacity.

The values of thermal diffusivity identified by IT '905 enable a satisfactory operation of the single storage device for thermal energy and of an array of such devices as regards the performance requirements of general users, i.e., the delivery of a constant thermal power for a given time duration (operational autonomy). This is achieved through the delivery of a constant flow rate of the thermovector fluid at a constant temperature (both being defined by the users). During the discharge of the thermoaccumulator unit, the latter will release part of its internal energy to the thermovector unit, which will adapted to be be traversed by the thermovector fluid destined to the users with a constant flow rate, as long as the thermoaccumulator unit has a sufficient residual “charge” (internal energy). This is generally true irrespective of the nature, the shape and the structure of the thermoaccumulator unit and of the thermovector unit.

However, the inventors have observed that the thermal energy storage device implemented according to IT '905 the of requires use extremely costly thermoaccumulator materials, especially in the case of big sized storage devices. In other words, albeit offering good performances as regards the storage and the release of thermal energy, the costs for the manufacture and the implementation of such a storage device eliminate nearly completely the benefits thereof, so that more conventional solutions are preferred for inputting thermal energy into a thermovector fluid.

### OBJECT OF THE INVENTION

The present invention aims at solving the technical problems mentioned in the foregoing. Specifically, the present invention aims at providing a storage device for thermal energy adapted to offer the same performances as the devices having a thermoaccumulator material with high thermal diffusivity, and requiring lower manufacturing and installation costs. Further objects of the invention comprise a reduced need for maintenance, a high energetic efficiency during both the charging and the discharging step, controllable charging and discharging times, a high ratio between the exchange power and the mass of the system, a constant flow rate delivery to the user at a constant temperature (or, equivalently, a constant thermal power), and a high flexibility as regards the possibility of a series or parallel connection, and generally as regards the possibility of building a modular thermoaccumulator array which minimizes the phenomena of back-mixing and of entropy increase.

### SUMMARY OF THE INVENTION

The object of the present invention is achieved by means of a storage device for thermal energy having the features according to one or more of the claims that follow, which form an integral part of the technical disclosure provided herein in relation to the invention.

### BRIEF DESCRIPTION OF THE FIGURES

The invention will now be described with reference to the attached Figures, which are provided by way of non-limiting example only and wherein:

FIG. 1 is a perspective, partially exploded view of a storage device for thermal energy according to the invention,

FIG. 2 is a perspective view along arrow II of FIG. 1,

FIG. 3 is a cross-section view along line III-III of FIG. 1,

FIG. 4 is a detailed view along arrow IV of FIG. 3,

FIG. 5 shows a possible solution for a connection into an array of devices according to the invention, and

FIGS. 6 and 7 are enlarged views according to arrows VI and VII of FIG. 5.

### DETAILED DESCRIPTION OF PREFERRED EMBODIMENTS OF

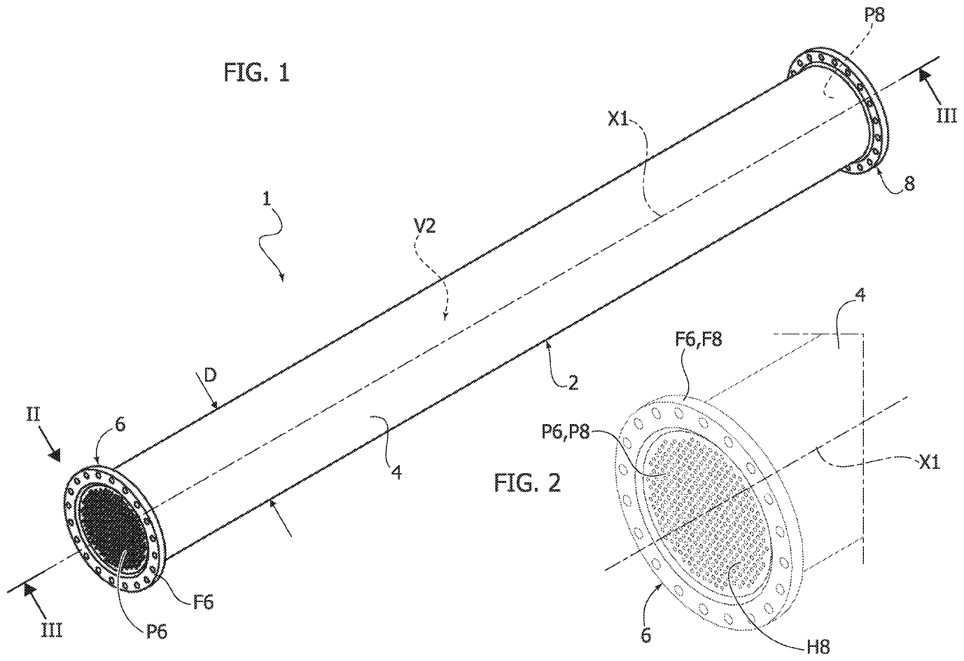

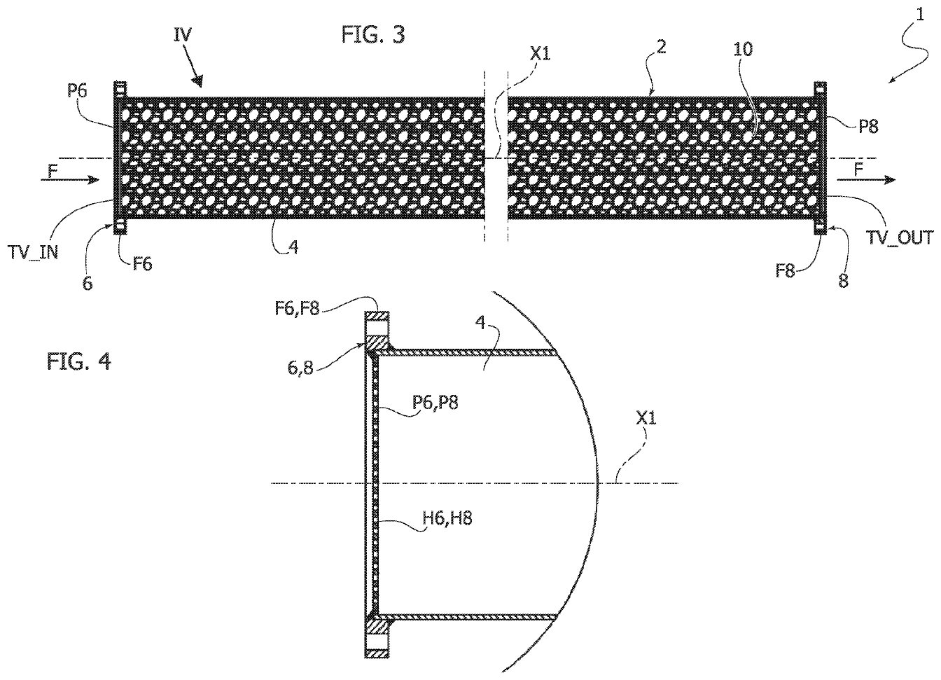

the Invention Reference 1 in FIGS. 1 to 4 generally denotes a storage device for according thermal energy to preferred embodiment of the invention.

The thermal energy storage device 1 includes a thermovector unit and a thermoaccumulator unit which are in thermal exchange relationship. As will become more apparent from the description of the Application, the distinction between the “thermovector unit” and the “thermoaccumulator unit” is essentially functional, because no real physical separation is provided for the two functional units.

Device 1 comprises a shell 2 having an internal volume V2 and including a tubular element 4 having an internal lumen, a first end element P6 at a first end of the tubular element 4 and a second end element P8 at a second end 8 of the tubular element 4, opposite the first end 6.

The first end element P6 and the second end element P8 moreover define, together with the internal lumen of tubular element 4, the internal volume V2 of shell 2.

According to the invention, the thermoaccumulator unit comprises a granular thermoaccumulator material 10, which is housed within the internal volume V2 of shell 2. The granular material is chemically inert to the thermovector fluid and is insoluble therein; moreover, it has an average characteristic dimension D₅₀ (which is defined as the maximum characteristic diameter of 50% of the mass of a batch of particles, i.e., equivalently, 50% of the mass of the particles have a characteristic dimension lower than said value) preferably comprised between 1.6 cm and 5.6 cm, more preferably between 2.4 cm and 4.8 cm, and still more preferably between 3.2 cm and 4 cm. The average characteristic dimension D₅₀ is determined according to the regulation/standard ISO 9276:2014 (“Representation of results of particle size analysis”). Moreover, the granular thermoaccumulator material is mechanically stable with respect to the thermovector fluid, and therefore withstands erosion by the thermovector fluid.

In the preferred embodiments, the granular material 10 comprises a mass of loose gravel elements of granite (granite being a rock predominantly consisting of silicon oxides, aluminium and potassium), quartz (essentially comprising silicon oxide) or generally speaking a mass of loose elements the average characteristic dimension whereof is comprised within one of the ranges stated in the foregoing, and the thermal diffusivity whereof is lower than or equal to 35 mm²/s (a requirement which is met both by granite and quartz).

The features of granular material 10 enable obtaining a thermovector unit substantially comprising an interstitial volume which is defined-within volume V2, and therefore within shell 2—by the granular material 10 of the thermoaccumulator unit, wherein the interstitial volume is pervious with respect to a thermovector fluid configured to flow through the interstitial volume (and globally through volume V2) in direction F, and being in thermal exchange a flow relationship with the granular thermoaccumulator material 10 of the thermoaccumulator unit, for the storage and release of thermal energy as a consequence of a thermal exchange with the thermovector fluid. Again, it is to be pointed out that the separation of the thermovector unit and the thermoaccumulator unit is essentially functional; the former is closely joined with the latter, it being an interstitial volume which is essentially flooded by the thermovector fluid when volume V2, so that the granular the latter enters material itself of the thermoaccumulator unit forms flow channels for the thermovector fluid. The interstitial volume extends therefore without interruption from end 6 to end 8, so that the thermovector fluid may transit throughout shell 2 without stagnating therein. In other words, there is always a path through granular material 10 which is pervious to the thermovector fluid throughout the bed of thermoaccumulator material.

The structure of the thermoaccumulator material 10 is dictated by the need of reducing the average distance between the bulk of the thermovector fluid and the bulk of the accumulator material, in order to enable the use of a material having low thermal diffusivity. In comparison with a traditional structure employing materials having a high thermal diffusivity, this leads to reducing the pitch between the conduits for the thermovector transfer fluid, which is condition which leads to an increase of the number of the conduits for the same rated operating conditions of the device, so as to be able to use all the volume (and therefore all the thermal capacity) of the thermoaccumulator material. Finally, in order to preserve the fluid dynamic arrangement within the conduits, and in order to have a convective thermal exchange coefficient sufficient to achieve the expected performances, it is moreover necessary to decrease the rated diameter of the conduits of the thermovector unit, until reaching excessively small dimensions which are impossible to implement. The practical solution to said various constraints consists, according to the invention, in the structure of the thermoaccumulator material 10.

In the preferred embodiment shown in the Figures, each end element, the first and the second, P6, P8 comprises a respective arrangement of holes H6, H8, configured to enable the transit of the thermovector fluid through the internal volume V2 the flow direction F, which in the present case generally coincides with a longitudinal axial direction X1 of device 1. The diameter of the holes of arrangements H6 and H8 is lower than the minimum of the average characteristic dimension of the loose elements of granular material 10, so as to avoid an undesired leak thereof from volume V2.

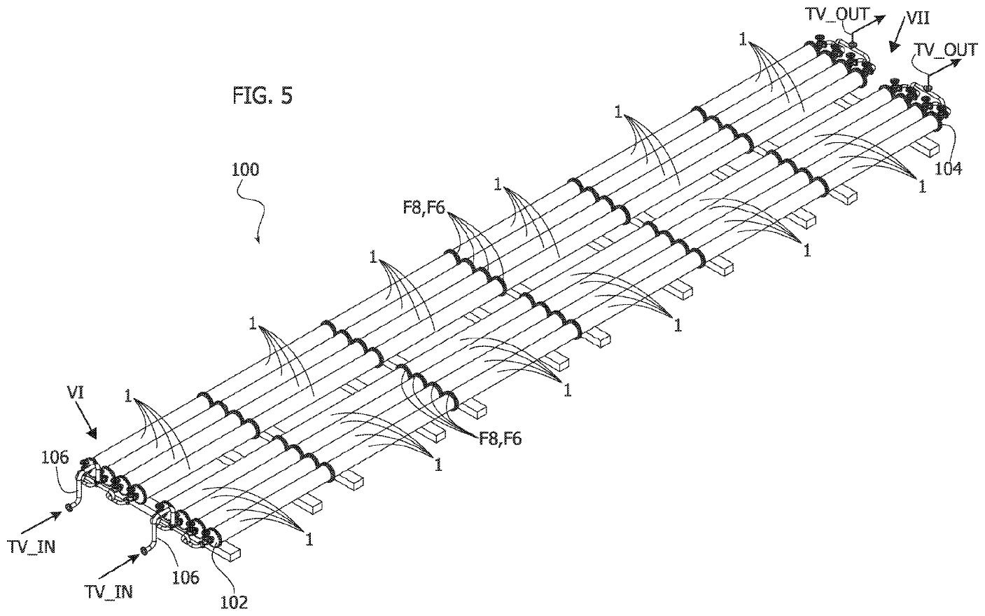

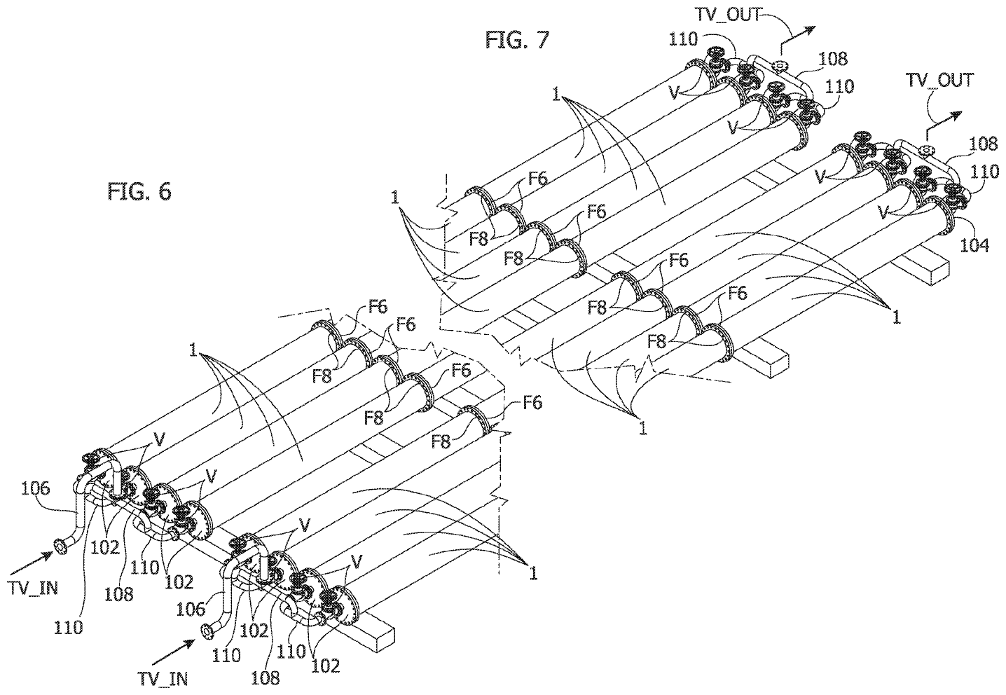

In preferred embodiments, as those shown in the Figures, device 1 moreover comprises a flange connection element F6, F8 at each end 6 and 8. The arrangement of flange connections F6, F8 makes it easier to assemble a plurality of devices 1 to form an array of storage devices, or simply the interface with hydraulic connection components. In this regard, FIGS. 5 to 7 show an exemplary embodiment of an array 100 of storage 1, which devices are mutually hydraulically connected in series by means of connecting flanges F8 and F6 of consecutive devices 1. In the embodiment of FIGS. 5 to 7, the hydraulic series of devices 1, which are all aligned along axis X1 thanks to the connection by way of the flanges F8 and F6, are organized into two arrays of four hydraulic series which are mutually connected in parallel. The devices 1 at the ends of each series are closed via caps 102 and 104 (the numbers denote the ends, but the caps in themselves may be identical) whereon flow control valves V are mounted. A thermovector fluid inlet TV_IN is provided at a hydraulic conduit 106 which is connected to a first forked conduit 108, the ends whereof are in turn connected to a third and a fourth forked conduit 110 having ends connected to the valves of cap 102. The same connection layout is provided on caps 104, which however is traversed in the opposite direction by the thermovector fluid, which initially collects in the conduits 110, then in conduit 108 and finally in conduit 106; it then exits at a thermovector fluid outlet TV_OUT.

The flow direction of the thermovector fluid within the series of devices 1 is substantially parallel to axis X1 of devices 1, as already described in the foregoing. By means of the valves V it is moreover possible to inhibit or enable the flow rate transit of thermovector fluid within the respective hydraulic series (each valve V is associated to the end of one hydraulic series), in such a way as to regulate the thermal power of array 100.

Referring both to the individual device 1 and to the array 100, the internal volume V2 has a characteristic dimension D transverse to the flow direction F of the thermovector fluid, and according to the invention a ratio between the average characteristic dimension D₅₀ of the granular material and the characteristic dimension D is comprised between 0.01 and 0.20, more preferably between 0.10 and 0.15. In the embodiment shown in the Figures, the shell 2 has a cylindrical shape (i.e., it comprises a tubular element 4 having a circular cross section): this implies that the characteristic dimension transverse to the flow direction F of the thermovector fluid comprises an inner diameter of shell as 2, conventionally construed and defined (amounting to four times the flow passage area divided by the so-called “wet perimeter”).

The width of the range of such ratio, which corresponds to a width of the granulometric distribution, is one of the parameters which most influences the functionality and the performances of the system, because it determines (together with other factors):
the thermal exchange efficacy between the thermovector fluid and the thermoaccumulator unit, all the higher, the smaller the average which is characteristic dimensions of the loose elements of granular material 10;
the amount of the charge losses experienced by the thermovector fluid while traversing the bed of thermoaccumulator material 10 are the higher, the smaller the average characteristic dimensions of the loose elements of granular material 10;
the degree of spatial segregation of the stored energy, intended as the width of the temperature transition region with respect to the total length of the storage device 1, as will be better detailed in the following; this is essential to ensure the delivery of a constant thermal power at a constant thermal level (temperature) to the users;
the exploitation efficiency of the thermal storage, intended as the residual stored energy evaluated in the instant when the power required by the users is no longer ensured, as will be better detailed in the following.

During installation, the granular material 10 may be easily accommodated within volume V2 by arranging the tubular element 4 in a vertical position and by letting the particles/the loose elements of granular material 10 take their places according to a random packing, if necessary by applying a light vibratory motion in order to obtain a certain degree of packing. This preferably implies that one of the two end elements P6 or P8 is fixed or welded in advance to the tubular element 4, and that the other end element is fixed or welded after the charging of the thermoaccumulator material 10.

Referring to the latter aspect, it will be noticed that, for the technical-economical and functional sustainability of the system, it is preferable to operate with a packing degree (i.e. with a filling degree) between 54 and 68%, or more preferably between 58 and 64%, which respectively correspond to a porosity (the so-called vacuum degree) between 32 and 46%, or more preferably between 36 and 42%. A vacuum degree lower than the inferior limit of said range would cause, with equal rated power and operating range of the storage system 1, excessive charge losses for the movement of the thermovector fluid through the fixed bed of thermoaccumulator material 10. On the other hand, a vacuum degree higher than the upper limit of said range would lead, always with equal rated power and operating range of the storage system 1, to the need of a greater amount of thermoaccumulator material, and therefore to an excessively big size of the system as a whole. Moreover, an excessive or anyway non-uniform vacuum degree leads to the establishment of preferential paths having lower fluid dynamic resistance to the flow of the thermovector fluid, thereby jeopardizing the performances of the system because of an unsatisfactory exploitation of the thermoaccumulator material 10.

In order to understand the scalability of the device 1 or of an array 100 of storage devices 1 hydraulically connected with one another, it must be kept in mind that the vacuum degree of a bed of particles having the same size and a spherical form does not depend on the size of the particles, and therefore it may be modified only by adding further particles, always spherical and equal to one another but having a smaller size, which may fill the voids present in the first batch. In a general real case, however, the particles with form a randomly packed bed are not spherical nor have the same size, but they are characterized by a size distribution which will determine a certain vacuum degree. In any case, for a satisfactory operation of the invention, it is vacuum uniform and envisaged that the degree controlled throughout the volume of the thermoaccumulator material 10, which may be achieved by employing particles having a “narrow” granulometric distribution, i.e. particles having sizes as similar to one another as possible. From a quantitative point of view, a “narrow” distribution of the particles size, which is preferred for the purposes of the present invention, is characterized by a value of ratio (D₉₀-D₁₀)/D₅₀, also known as distribution “span”, lower than 25%, preferably lower than 20%. The characteristic dimensions D₉₀ and D₁₀, exactly in the same way as D₅₀ (which are respectively defined as the maximum characteristic diameter of 90% and 10% of the mass of a batch of particles, i.e., in other words: 90% of the mass of the particles have a characteristic dimension lower than the given value, 10% of the mass of the particles have a characteristic dimension lower than the given value. The determination of such characteristic dimensions is achieved according to the regulation/standard ISO 9276:2014 (“Representation of results of particle size analysis”).

On the other hand, a “wide” distribution of the particle dimensions, which is not preferred for the implementation of the present invention, is characterized by way of example by a “span” higher than 70%. It must be pointed out that the confidence intervals of the “span” parameter for a satisfactory operation of an implementation which employs a batch of particles cannot be generalized, and are specific to the individual implementation. It must be pointed out, moreover, that the presently provided values are merely indicative, and that the operation of the invention is not impossible outside the indicated ranges, but it will be characterized by a lesser efficiency.

The device 1 or the array 100 of storage devices (the latter being a succession of devices interconnected in series) described herein preferably have a tubular elongated shape, and may be implemented with any length to diameter ratio, provided that this is compatible with the technical and practical constraints of implementation and with the maximum acceptable charge loss (for a determined operating flow rate).

If it is wished to operate with the same (1) total charge loss in the scaling passage between implementations having the same vacuum degree, accumulator material and operating temperatures (i.e. with the same density ρ, the same dynamic viscosity μ and—as a consequence—the same momentum diffusivity ν=μ/ρ of the thermovector fluid), but with a different rated storage capacity and/or rated operational autonomy, the following requirements must be met:
in the case of a laminar flow (Reₚ<10):

$${L}^{2} \cdot Q / ( V \cdot {{d}_{p}}^{2} ) = constant$$

in the case of a turbulent flow (Reₚ>1000):

$${L}^{3} \cdot {Q}^{2} / ( {V}^{2} \cdot {d}_{p} ) = constant$$

in the case of a transitional flow (10<Reₚ<1000):

$${L}^{2} \cdot Q / ( V \cdot {{d}_{p}}^{2} ) + ( {c}^{′} \cdot {L}^{3} \cdot {Q}^{2} ) / ( {V}^{2} \cdot {d}_{p} ) = constant$$

wherein Reₚ=ρuₛdₚ/μ (1−ε) is the Reynolds number referred to the surface speed uₛ=Q/A and to the particle diameter dₚ, A is the fluid cross section passage, L is the total length of the storage system 1 (along axis X1 or generally along the flow direction F), Q is the rated volume flow rate of the thermovector fluid required by the users, V is the total volume of the storage system, c′=(1.75/150)·ν·(1−ε) is a constant characteristic of the material at given operating conditions, wherein the numerical values 1.75 and 150 are the standard values of the well known Ergun equation, and may be determined experimentally for every given batch of particles.

On the other hand, if it is wished to operate with the same fluid dynamic regime, in every case of scaling passage with respect to the rated storage capacity or to the rated thermal power or to the rated operational autonomy of the device or array 100 of devices provided herein, it is always necessary to respect the condition of similarity described by the following relation, wherein the terms have the same meaning as in the previous expressions:

$$Q \cdot {d}_{p} / D = constant$$

which corresponds to the condition of parity of Reynolds number. Indeed, under the scaling constraints mentioned (same vacuum degree, same thermoaccumulator material 10 and same operating temperatures), the fluid dynamic similarity ensures obtaining the same Nusselt number Nu and, as a consequence, a convective thermal transfer coefficient h=dₚNu/k_{f} which is scaled, in comparison with the reference case, only proportionally to the diameter dₚ of the particles of the thermoaccumulator material 10.

On the contrary, while operating in conditions of equal working autonomy (3), the condition of a scaling passage with respect to a reference case envisages keeping the ratio between capacity and power of the storage system constant, the because former is proportional to the total storage volume V and the latter may be considered largely similar (assuming a perfect thermal insulation) to the maximum exchanged thermal power (either received or released) of the thermovector fluid. Under the scaling constraints mentioned in the foregoing (the same vacuum degree, the same thermoaccumulator material 10 and the same operating temperatures), this translates into the following relation, wherein the terms still hold the meaning they had in the previous expressions:

$$V / Q = constant$$

The operation of the storage device 1 for thermal energy is as follows.

Irrespective of the operating range (limit conditions for temperature and flow rate) for which the storage device 1 (or the array 100 of storage devices 1) has been designed, a method is described herein which enables obtaining the thermal storage and power transfer performances from and towards the thermovector fluid, according to the users' needs.

Let us assume, as the initial state of the duty cycle, a state wherein the whole mass of thermoaccumulator material 10 is approximately at the same temperature, corresponding to the lower limit of the rated operating range, and at the same time the mass of thermovector fluid stationing within the fixed bed of thermoaccumulator material 10 is in conditions of thermal balance with it.

In the moment when a certain flow rate of thermovector fluid becomes available, because it is produced or derived from any third thermal source, the temperature whereof is higher than the temperature of the system, such flow rate is sent, e.g. by means of a feeding unit and/or a system of hydraulic valves, as an input to the first device 1 or unit of parallel storage devices 1. When the hot thermovector fluid (which in any case has a temperature higher than the thermoaccumulator u unit 10) starts circulating in the one or more storage devices, soaking the fixed beds of thermoaccumulator material 10 located therein, the so-called “charging step” begins.

Preferably, the inlet temperature during the charging step must correspond to the maximum temperature of the duty cycle for which the storage system has been designed, and—in order to achieve the best performances in terms of operational autonomy, of specific storage capacity and of operating versatility—it must preferably be far higher than the maximum temperature required by the users.

During the charging step, the thermovector fluid traverses the storage device 1 or the series of storage devices along the direction of longitudinal extension thereof (X1), in a given moving direction which corresponds to the flow direction F. The hot fluid releases heat to the grains or gravel of thermoaccumulator material 10, thereby cooling down until reaching a thermal balance with the latter, which at the same time heats up. The insulation of shell 2 with respect to thermal dissipations towards the external environment is such that during the charging transient the dissipated thermal energy is negligible in comparison with the thermal energy which is transferred from the thermovector fluid to the thermoaccumulator material 10.

By feeding the flow rate of hot thermovector fluid for a sufficiently long time, which depends on the input conditions, on the design specifications and on the requirements of the users, the bed portion of thermoaccumulator material 10 which reaches the thermal balance with the incoming thermovector fluid will become more and more extended, thereby enabling locating and distinguishing the so called “charged” region from the so called “discharged” region. The separation boundary between both regions is described by the front of thermal advancement, which typically shows a sigmoid shape, as will be better detailed in the following referring to the performance parameters of the system.

Generally speaking, the advancement speed of the thermal front may not coincide with the outflow speed of the thermovector fluid, depending on the thermal properties and the transport properties of the accumulator material and of the thermovector fluid which, together with the imposed operating conditions (flow rate or speed) determine the relative magnitude of the conductive and convective phenomena.

The charging step may be considered completed when the advancement front has reached the end section of the storage device 1 or of the array 100 of storage devices, or when the average temperature of the whole volume of thermoaccumulator material 10 has reached a predetermined desired percentage of the rated operating range.

At the end of the charging step, or in any case when no more hot thermovector fluid is available (which may occur, for example, when the primary source of the hot fluid is intermittent, such as. e.g. solar or wind power), it is necessary to interrupt the circulation within storage device 1 or within the array 100 of devices 1, by acting on the power unit or on the corresponding hydraulic valves.

The charging step may be resumed at any moment, by repeating the described actions, even on different days which may not be consecutive, by re-starting every time from the last reached step with a minimum degradation of the stored energy, because the insulation of shell 2 limits the dissipations towards the environment, and the stagnation of the thermovector fluid between the grains or gravel elements of the thermovector material 10 limits the phenomena of convective dissipation. The only reason for the thermal levelling between distant regions of the thermoaccumulator material 10 is always the thermal conduction within the elements of thermoaccumulator material 10 and within the stagnating thermovector fluid.

When the user needs thermovector fluid having given flow rate and temperature, presumably at times when the primary source is not available (e.g. in the evening or late in the night), it is sufficient to act on the valve system or on the power unit of the thermovector fluid, in order to send, into the storage system which is already partially or completely charged, the required flow rate of so-called “cold” fluid. In this way the so-called “discharging step” is started. The flow direction of the thermovector fluid during the discharging step is the same as in the charging step, but the flow direction is opposite. Therefore, the charging of the storage device 1 may take place, for example, with a “hot” thermovector fluid fed from end 6 to end 8, while the discharging may take place with a “cold” thermovector fluid fed from end 8 to end 6.

The same is true if the charge thermovector fluid is a “cold” fluid, i.e. a fluid having a temperature lower than the discharge thermovector fluid (which becomes a “hot” fluid).

In this way, the cold thermovector fluid traverses regions wherein the thermoaccumulator material 10 has increasingly high temperatures, because it was charged first during the previous charging step(s) and thus has reached first the thermal balance with the hot thermovector fluid.

The cold fluid used in the discharging step must preferably be input at the rated minimum temperature of the duty cycle: obviously, if the input temperature is lower than the minimum limit of the rated working range, the operational autonomy will be lower than rated, and vice versa in the opposite case.

Also during the discharging step it is possible to distinguish between the “charged” storage region and the “discharged” storage region, separated by the front of thermal advancement which, during the transient period, will translate into the opposite direction with respect to the charging step.

The discharging step may be considered completed when the thermal front has reached the opposite end section of the sequence of storage devices (the end which, during the charging step, was the inlet section), which corresponds to the moment when the users no longer receive the desired flow rate at the desired temperature, as will be better detailed in the following.

Similarly to the charging step, also the discharging step may be interrupted and resumed at any moment according to the users' needs, even alternated by recharging periods (by inverting the flow, as described in the foregoing) if the hot thermovector fluid is temporarily available.

An auxiliary heating system employing traditional fuels (e.g. a gas boiler) which is installed in a closed circuit parallel to the lines of the charging and discharging circuits, and which is provided with an independent circulation, may conveniently be coupled with the device 1 or the array 100 of storage devices 1, in order to enable keeping the system sufficiently hot if, during the inoperative periods, the average temperature falls below the lower limit of the rated operating range or, more generally, in order to compensate for the thermal dissipations. In this case, a give flow rate of cold thermovector fluid is sent to the auxiliary circuit, in order to be heated to the desired temperature (so-called “holding temperature”) and then to be sent to the storage array 100. This specific step of the duty cycle is denoted as “holding step”, and it is useful particularly during the night cycles powered by solar energy, in order to enable maintaining the rated minimum thermal level during the night, so that the following day the normal charging-discharging cycle may be resumed.

### Performance Parameters for the Evaluation of the Performances of the Storage Device According to the Invention

After describing the operation and the duty cycle of the device 1/of an array 100 of storage devices 1, we will consider the following parameters which are commonly denoted in the field with the phrase figure of merit (FOM), i.e. performance indicators which are capacity of the useful to characterise the storage thermal storage systems.

i) Specific storable energy (E_{wt}): the maximum absorbable energy during charging or, similarly, releasable during discharging—with the same range of operating temperature—by the mass unit of the accumulator material from/to the thermovector fluid, and therethrough available to the user, also including the absorbed/released energy when the thermoaccumulator material undergoes phase changes (melting solidification or boiling/liquefaction),

ii) Volumetric storable energy (Eᵥₒₗ): the maximum absorbable energy during charging or, similarly, releasable during discharging—with the same range of operating temperature—by the volume unit of the accumulator material from/to the thermovector fluid, and therethrough available to the user, also including the absorbed/released energy when the thermoaccumulator material undergoes phase changes (melting 1 solidification or boiling/liquefaction).

A material having high E_{wt} values—and, in the same way, having high Eᵥₒₗ values—can accumulate a greater amount of energy, respectively per mass unit or per volume unit, in comparison with a material having low E_{wt} or low Eᵥₒₗ values.

iii) Maximum operating temperature (Tₘₐₓ): the maximum allowable temperature for the accumulator material before reaching a thermal deterioration thereof, i.e. such as to preserve the chemical-physical identity and integrity of the material.

When selecting the thermoaccumulator material, it is preferable to choose a material having a high Imax, so that it is adapted to accumulate energy of a better quality, because it is available at a higher temperature in comparison with a material having a low Tₘₐₓ, provided that the power source, the thermovector fluid and the system of hydraulic conduits are compatible with said high Tₘₐₓ.

iv) Thermal diffusivity (α): the ratio between the thermal conductivity (k) of the thermoaccumulator material (if it is solid, as in the present case, or if it is adapted to exchange heat exclusively by means of conductive motion), or the equivalent thermal conductivity (as defined in the following, if the material is liquid, or if it is adapted to exchange heat also by means of convective motion) and the product of the specific heat (cₚ) by the density (ρ) thereof: this physical value is an intrinsic property of the thermoaccumulator material 10 (as a function of the temperature thereof) because it depends exclusively on the properties thereof, and it is useful for describing the propagation in a thermal field in non-stationary conditions.

v) Characteristic time constant of the individual storage module 1, representing the time needed to reach 63,2% of the storage capacity. Similarly to the time constant of an electric circuit RC, in the present case the time constant only depends on the intrinsic characteristics of the thermoaccumulator material 10 employed and by the system geometry. Specifically, in the case of a solid thermoaccumulator material, the time constant may be expressed as:

$$τ = ( λ / {K}_{acc} ) / ( {n}_{tubes} \cdot {S}_{tube} ) \cdot {ρ}_{acc} \cdot {V}_{acc} \cdot {c}_{p , acc}$$

wherein λ is a characteristic measure of the equivalent average distance of heat exchange between the thermovector unit and the thermoaccumulator unit (penetration distance of the thermal wave, which can be evaluated experimentally), k_{acc}, ρ_{acc}, c_{p,acc} are respectively the thermal capacity, the density and the specific heat of the accumulator material (average values in the range of the operating temperature), n_{tubes} is the number of tubes of the thermovector unit (if the thermovector unit has a multi-tube configuration embedded in the thermoaccumulator unit) or—in a more appropriate fashion for the present invention—the number of parallel hydraulic ways into which the total flow rate of the thermovector fluid is divided, s_{tube} is the exchange surface between the thermovector unit and the thermoaccumulator unit, v_{acc} is the volume of the thermoaccumulator unit.

On the other hand, in the case of liquid accumulator material, the time constant may be expressed as:

$$τ = ( λ / {K}_{acc , eq} ) / ( {n}_{tubes} \cdot {S}_{tube} ) \cdot {ρ}_{acc} \cdot {V}_{acc} \cdot {c}_{p , acc , eq}$$

wherein the symbols keep the physical meaning of the case of the above solid material, with the exception of k_{acc,eq} which is the equivalent conductivity of the accumulator liquid and c_{p,acc,eq} which is the equivalent specific heat of the accumulator liquid.

The equivalent conductivity of the accumulator liquid is a conductivity incremented by a factor of Nu, i.e. Nusselt number,

$${K}_{a c c , e q} = {K}_{a c c} \cdot Nu$$

in order to take into account the presence of natural convective motion, the latter being defined as:

$$Nu = h \cdot L / K$$

wherein h is the heat exchange coefficient by way of natural convection, L is a characteristic distance of the system and k is the thermal conductivity. The Nusselt number for a given system may be derived from which empirical correlations, are widespread and available in literature, and which may be applied to systems having different and various geometries and layouts of the conduits subjected to mass and thermal flows, and as a function of the flow regimes (natural or forced flow), about which we refer to other sources.

In the simplified hypothesis that the thermoaccumulator fluid is subjected only to one change of state during the duty cycle (melting/solidification or, alternatively, boiling/condensation), the equivalent specific heat of the accumulator liquid may be defined as:

$${c}_{p , a c c , e q} = {c}_{p , a c c} + Γ / ( {T}_{cf} - {T}_{rif} )$$

wherein Γ is the latent heat of change of state (melting/boiling in the charging step, solidification/condensation in the discharging step), T_{cf} is the temperature at which the change of state takes place, T_{rif} is a reference temperature (similar to the minimum temperature of the duty cycle during the charging step, or to the maximum temperature of the duty cycle during the discharging step), c_{p,acc} is the specific heat of the accumulator material (as an average between the change of state temperature and the reference temperature).

Moreover, it must be kept in mind that the present invention substantially does not envisage a forced movement of fluids employed as thermoaccumulators, so that reference may be made to the mechanism of heat transport by way of conduction or, at most, to the mechanism of natural convection, although the latter may cause a degradation in time of the quality of the stored energy, for the reasons stated in the above description.

Similarly to what is known in the electrotechnical field with reference to a simple RC circuit, the time constant is useful for determining the duration of the charging and discharging transients of the system: the charging/discharging transient may be considered as completed after a time amounting to 5τ.

vi) Average charging time for unit of accumulated energy (τ_{spec}), which represents the time needed to reach a charge of 99, 3%, in the individual module 1, standardized with reference to the stored energy:

$${τ}_{spec} = 5 τ / ( {E}_{wt} \cdot {m}_{a c c} ) = 5 τ / ( {E}_{v o l} \cdot {V}_{a c c} )$$

A system having high τ_{spec} values requires a long time to store/release the unit of thermal energy in the charging/discharging step, and therefore has worse performances in comparison with a system having low τ_{spec}, with the same operating conditions of the duty cycle.

vii) Exchange surface needed per unit of transferred thermal power (σ_{τ}), which gives an indication of the exchange surface between the thermovector fluid and the accumulator material needed to transfer the unit of thermal energy per time unit, until reaching a charge of 63,2%: this index is conceptually similar to the reciprocal of the thermal flow exchanged between the thermovector fluid and the thermoaccumulator material 10, evaluated after a time corresponding to the characteristic constant τ of the system (63,2% of charge):

$${o}_{τ} = {S}_{e xchange} \cdot τ / {E}_{τ}$$

wherein Eₜ is the energy stored after a time t, corresponding to 63, 2% of the maximum storable energy.

This parameter is useful for comparing storage systems which are characterized by different materials well as different geometries, both of the as thermoaccumulator unit and of the thermovector unit, because the mutual exchange surface is involved.

A system having high values of Or would require larger exchange surfaces for transferring the unit of thermal power during charging/discharging, with the same achieved charge, and as a consequence it would be bulkier and more complex due to the higher number of necessary tubes, with the same total stored energy, in comparison with a system having low σ_{τ} values.

viii) Average degree of spatial segregation of the stored energy: it is an indirect measure of the entropy of the thermoaccumulator unit, and may be evaluated accurately by knowing the thermal profile along the direction of longer extension of the storage system 1 (specifically, in the present invention, it is the longitudinal direction X1 along which the thermovector fluid flows). The more the temperature distribution follows a so-called “stepwise” profile, the higher the spatial segregation degree and the more efficient the exploitation of the stored energy. According to an advantageous aspect of the present invention, the operating conditions and the thermophysical and geometric features of the thermoaccumulator unit enable employing a thermoaccumulator material 10 having low thermal conductivity, thereby obtaining the same performances as materials which have a high thermal conductivity but are much more expensive.

From a purely mathematical point of view, the variation of a scalar quantity (in the present case, the temperature) in a space interval which is ideally concentrated in an infinitesimal section (“width” of the step) leads to a gradient of infinite magnitude. Generally, however, the real shape of the profile always follows a so-called “sigmoid-shaped” course, enabling locating a space region wherein the temperature variation takes place between the part of the theromoaccumulator group which is completely “charged” (i.e., which has the maximum temperature of the duty cycle) and the part of the thermoaccumulator group which is completely “discharged” (i.e., which has a temperature equal to the minimum temperature of the duty cycle). In order to evaluate with mathematical precision the degree of spatial segregation of the stored energy it is possible to assume, as a measurement point of the temperature gradient, the middle point of said spatial region. The greater the gradient, the higher the inclination of the “step”, the steeper the thermal profile and the higher the segregation degree of the stored energy.

However, for practical purposes and for the functional s of aims the storage device 1, the segregation degree s of the stored energy may be correctly evaluated by means of the following expression, in a general operating instant taken at random, at the cross section in the midline of the storage system, irrespective of the operating temperature difference:

$$s = ( 1 - Δ {x}_{95} / {L}_{T O T} ) \cdot 100$$

wherein Δx₉₅ is the spatial length in which 95% of the thermal gap is reached between the maximum operating temperature and the minimum operating temperature, and L_{TOT} is the total length of the device or of the array 100 of devices connected in series.

Therefore, irrespective of operating the temperatures, a spatial segregation is obtained which is all the greater, the smaller the width of the temperature transition region with respect to the total size of the storage system.

A thermal profile which closely approaches a “stepwise” shape may be obtained by correctly choosing the type and the average size of the thermoaccumulator material. Limiting the discussion, for simplicity, to the materials having a thermal diffusivity lower than or equal to 35 mm²/s according to the present invention, when the thermal diffusivity increases and/or when the average size of the particles of the thermoaccumulator material 10 decreases, the degree of spatial segregation rises, because the thermal profile gets closer to a perfect “step”.

The material selected for the preferred embodiment of the invention (granite or quartz) and the granulometric distribution of the gravel particles as mentioned above (ranging from 1.6 cm to 5.6 cm) are such as to obtain performances, as regards the readiness of thermal transfer with same total the storage capacity, equal to or better than those of materials having high thermal conductivity (aluminium, cast iron, graphite) having much higher values of thermal diffusivity.

In the present invention, a confidence interval has been found for the performance parameter s, only regarding materials having thermal diffusivity lower than or equal to 35 mm²/s. Referring to the characteristics of the invention (type and geometry of the system, type and size of the thermoaccumulator material) and using, in the case of a scaling passage, the presently provided relations, the degree of spatial segregation s is comprised between 75% and 85%, depending on the lowest and highest values of the granulometric distribution of the thermoaccumulator 10.

ix) Exploitation efficiency of the thermal storage: it is a second performance index which indicates the percentage of residual charge of the storage device 1 or of the array 100 of storage devices being evaluated, during the discharging step, when the device or the array is no longer able to deliver the rated operating power, i.e. the combination of flow rate and temperature required by the users. The comparative evaluation of different storage systems must be carried out with the same rated operating conditions of the storage system, which are fixed and known (minimum and maximum operating temperature, temperature and flow rate required by the users).

The percentage of residual charge may be evaluated, according to the characteristics of the present invention, with this sort of expression:

$${η}^{★} = ( {E}_{R E S} / {E}_{MAX} ) \cdot 100$$

wherein E_{RES} is residual stored energy the evaluated in the instant when the device 1 or the array 100 of devices 1 no longer delivers the power required by the users, irrespective of the operational autonomy required by the users (the latter being modulable simply by oversizing the storage array 100), while E_{MAX} is the maximum storable energy, which may be calculated—in the general case of thermophysical properties depending on the temperature—by means of the relation:

$${E}_{MAX} = ρ ( {T}_{MAX} ) {c}_{p} ( {T}_{MAX} ) {T}_{MAX} - ρ ( {T}_{MIN} ) {c}_{p} ( {T}_{MIN} ) {T}_{M I N}$$

wherein T_{MAX} and T_{MIN} are respectively the maximum and minimum temperature of rated operation of the storage system, at which density p and specific heat cₚ of the thermoaccumulator material are evaluated. In other words, the above relation evaluates the difference of content of the enthalpic thermoaccumulator material between the condition of complete discharge (T_{MIN}) and the condition of complete charge (T_{MAX}), evaluated with reference to the same reference temperature, amounting to 0 degrees, in the chosen temperature scale.

The residual stored energy of the thermoaccumulator material when the system no longer delivers both the flow rate and the temperature required by the users may be evaluated with accuracy by knowing the temperature distribution in the whole system, because such distribution, generally speaking, may be defined mathematically as the volume integral of the product of density, specific heat and (local) temperature of the thermoaccumulator material 10 (hence, the necessity to know the thermal profile).

From the point of view of the users' requirements, the device 1 or the array 100 of storage devices 1 must be considered discharged when they can no longer deliver the required power at the required temperature, although they may go on delivering, even for a long time, a reduced power (lower flow rate at the required temperature or lower temperature at the required flow rate). The lower the residual stored energy (residual charge) at the end of the discharging process, the higher the exploitation efficiency of the storage system.

For practical purposes and for the functional goals of the storage device 1, the exploitation efficiency and the thermal storage efficiency may be conveniently evaluated with the following expression, as a complement to 100 of the percentage of residual charge:

$$e = ( 100 - {η}^{★} )$$

A storage device according to the invention is to be considered discharged (for the users) when it has a residual charge percentage comprised between 7% and 18%, depending on the lowest and highest value of the granulometric distribution of the thermoaccumulator material 10, which corresponds to an exploitation efficiency of the thermal storage between 82% and 93%.

Of course, in the absence of an effect of spatial segregation of the heat, which concentrates the temperature gradient in a limited spatial region, achieving a thermal profile along the direction of the main length of the system (the region of movement of the thermovector fluid, i.e. the direction of flow F) as close as possible to the “stepwise” profile, it would not be possible to obtain a constant power for the users at the required constant thermal level (temperature).

In other words, the users may take advantage of the storage system at the maximum rated power (the required combination of flow rate and temperature) even with a rather low level of residual charge, which would not be possible, for example, with any storage system suffering from degradation of the stored energy for irreversible effects of back-mixing (hot fluid masses in thermofluidodynamic continuity with cold masses).

x) A third index to evaluate a thermal storage system according to the invention is the Biot number, a dimensionless coefficient used for estimating the relative influence of convective and conductive phenomena in systems comprising solids immersed in fluids, which as known is defined as:

$$Bi = h \cdot {d}_{p} / {K}_{s}$$

wherein h is the coefficient of convective thermal exchange, dₚ is the characteristic size of the solid particle and kₛ is the thermal conductivity of the solid material.

Unlike the former two performance parameters (indexes), which indicate performances which may be referred to the longitudinal extension of the system, the Biot number enables evaluating the phenomena of the thermal exchanges in one and the same cross section of the storage system, i.e., the distribution of the thermal gap between the bulk of the thermovector fluid and the bulk of the particles of thermoaccumulator material 10.

According to the present invention, in order to obtain, with so called insulating materials (with low thermal conductivity, and therefore with low thermal diffusivity), performances similar to what may be obtained with materials high thermal having diffusivity, the Biot number is preferably comprised between 0,1 and 10, or more preferably amounts approximately to one unit, which indicates the fact that the conductive resistances must preferably be comparable to the convective resistances.

Such an observation may be confirmed also in an analogy between thermal and electrical phenomena, as already illustrated by the formula as per item v) above. As a matter of fact, in this regard, it is well known that in purely resistive (ohmic) electric systems the maximum delivery of power by a voltage generator takes place when the total resistance of the circuit equals the internal resistance of the generator. Similarly, the maximum power exchange between the bulk of the thermovector unit and the bulk of the thermoaccumulator (which, for the thermal unit exchange, have a mutual connection in series) takes place when the respective internal thermal resistances have a comparable magnitude. In other words, no resistance to the heat transport (convective resistance in the thermovector fluid and conductive resistance in the solid thermoaccumulator material) acts as a bottleneck, i.e., as a controlling resistance for the process.

xi) For a thermal storage system according to the invention, it is possible to identify a fourth yield index, the average rate of specific energy loss λ, defined as the ratio between the net hydraulic energy which must be transferred the thermovector fluid in order to support the hydraulic losses and the rated capacity of the storage system net of thermal dissipations:

$$λ = Q \cdot Δ P \cdot Δ t / ( 1 - ε ) \cdot V \cdot {c}_{p} . Δ T$$

wherein ΔP is the total charge loss of the thermovector fluid flowing along the bed of thermoaccumulator material 10, Δt is the operational autonomy and the other symbols keep the same meaning as above. All the physical properties and, consequently, the amount of the charge losses, are evaluated as average values between the minimum and the maximum operating temperatures.

While respecting at least one of the scaling analogies described in the foregoing it is possible to identify (at least) one constructive geometry enabling having a specific loss rate lower than 1% (1 kWh of energy used for the movement of the thermovector fluid per 100 kWh of energy stored in the system, net of all the losses due to thermal dissipation).

A thermal energy storage device 1 according to the invention, considered in itself or as an array as shown in FIGS. 5 and 7, globally offers remarkable advantages:
it is preferably implemented with tubular elements 4, which define conduits having a large diameter and being filled with granite or quartz gravel (by way of non-limiting example only) as a fixed bed of thermoaccumulator material 10,
the thermovector fluid is in intimate contact with the thermoaccumulator material 10, by flowing through the interstitial volume of the bed of thermoaccumulator material,
the average characteristic dimension of the particles/of the loose elements of the thermoaccumulator material 10 and the granulometric distribution (the ratio between the average characteristic dimension of the particles of the loose elements of the thermoaccumulator material 10 and the characteristic of dimension the volume V2 transverse to the flow direction F) is such that the convective phenomena within the thermovector fluid are made comparable to the conductive phenomena within the thermoaccumulator material 10,
thermofluidodynamic equivalence with a system having an infinite number of parallel capillary conduits which are tortuously interconnected with one another, so as to obtain good convective thermal exchange coefficients within the thermovector fluid and so as to enable the use of cheap accumulator materials, which are however typically insulating or in any case exhibit low thermal diffusivity, while obtaining the same performances as the storage systems based on materials having high thermal diffusivity,
a high degree of spatial segregation of the stored energy, which may be evaluated from the shape of the average thermal profile of the storage system as a whole, and particularly from the average temperature gradient which may be calculated as the ratio between the existing thermal gap between the hot (charged) region and cold region the (discharged) of the thermoaccumulator material 10 and the spatial distance wherein said thermal gap is located,
high exploitation efficiency of the storage in comparison with the rated operating conditions, which may be evaluated from the percentage of residual charge in the instant when the system is discharged for the users (i.e. for fixed requirements of thermal power and temperature),
an efficient thermal energy exchange between the thermovector unit and the thermoaccumulator unit, as may be seen by the achievement of a Biot number approaching the unit.

Of course, the implementation details and the embodiments may be amply varied with respect to what has been described and illustrated herein, without departing from the extent of protection of the invention, as defined by the annexed claims.

1. A thermal energy storage device including:
a thermovector unit, and
a thermoaccumulator unit,
wherein:
said thermoaccumulator unit comprises a granular thermoaccumulator material,
said thermoaccumulator unit comprises an interstitial volume defined by the granular thermoaccumulator material of said thermoaccumulator unit, said interstitial volume being pervious with respect to a thermovector fluid configured to flow through the interstitial volume in a flow direction and in thermal exchange relationship with the granular thermoaccumulator material of the thermoaccumulator unit for the storage and release of thermal energy as a consequence of a thermal exchange with said thermovector fluid,
said granular thermoaccumulator material is arranged in an internal volume of a shell of said thermal storage device,
said internal volume has a characteristic dimension transverse to the flow direction of the thermovector fluid, and
a ratio between an average characteristic dimension of the granular thermoaccumulator material and said characteristic dimension transverse to the flow direction of the thermovector fluid is comprised between 0.01 and 0.20.

2. The thermal energy storage device according to claim 1, wherein said ratio between the average characteristic dimension of the granular thermoaccumulator material and said characteristic dimension transverse to the flow direction of the thermovector fluid is comprised between 0.01 and 0.15.

3. The thermal energy storage device according to claim 1, wherein said granular thermoaccumulator material has the average characteristic dimension between 1.6 cm and 5.6 cm.

4. The thermal energy storage device according to claim 1, wherein said granular thermoaccumulator material is chemically inert to the thermovector fluid and insoluble therein.

5. The thermal energy storage device according to claim 1, wherein said granular thermoaccumulator material has thermal diffusivity lower than or equal to 35 mm²/s.

6. The thermal energy storage device according to claim 1, wherein said shell has a cylindrical shape, said transverse characteristic dimension with respect to the direction of flow of the thermovector fluid comprising an internal diameter of said shell.

7. The thermal energy storage device according to claim 1, wherein said shell has a prismatic shape, said characteristic dimension transverse to the flow direction of the thermovector fluid being a hydraulic diameter of the shell, said hydraulic diameter being defined as a ratio between a quadruple of a flow section of the internal volume of the shell and a wet perimeter of the internal volume of the shell.

8. The thermal energy storage device according to claim 4, wherein said shell comprises:
a tubular element having an internal lumen,
a first end element at a first end of the tubular element,
a second end element at a second end of the tubular element, opposite to said first end,
the first end element and the second end element defining, with said internal lumen of the tubular element, the internal volume of the shell,
each of said first and second end elements comprising a respective arrangement of holes configured to enable transit of said thermovector fluid through said internal volume in the flow direction.

9. The thermal energy storage device according to claim 1, wherein said granular thermoaccumulator material has a span lower than 25%, wherein said span is defined as a ratio between multiple characteristic dimensions of said granular thermoaccumulator material.

10. An array of thermal energy storage devices including a plurality of thermal energy storage devices according to claim 1 hydraulically connected to each other.
